(19) United States
(12) Patent Application Publication
(10) Pub. No.: US 2013/0076771 A1
(43) Pub. Date: Mar. 28, 2013

(54) GENERATING A VISUAL DEPICTION OF A COVER FOR A DIGITAL ITEM

(71) Applicants: William M. Bachman, San Jose, CA (US); Deborah E. Goldsmith, Los Gatos, CA (US); Louie Mantia, San Francisco, CA (US); E. Caroline F. Cranfill, San Francisco, CA (US); Melissa Breglio Hajj, San Francisco, CA (US)

(72) Inventors: William M. Bachman, San Jose, CA (US); Deborah E. Goldsmith, Los Gatos, CA (US); Louie Mantia, San Francisco, CA (US); E. Caroline F. Cranfill, San Francisco, CA (US); Melissa Breglio Hajj, San Francisco, CA (US)

(73) Assignee: APPLE INC., Cupertino, CA (US)

(21) Appl. No.: 13/244,000

(22) Filed: Sep. 23, 2011

(51) Int. Cl. G09G 5/00

(52) U.S. Cl. 345/581; 345/629

(57) ABSTRACT

Techniques for generating a visual depiction of a cover for a digital item are provided. A base-depiction-selector-value is generated based on one or more values from attribute metadata associated with the digital item. A mapping table is then accessed to select a base visual depiction item using the base-depiction-selector-value. A visual depiction of a cover is generated for the digital item based at least in part on the selected base visual depiction item. The visual depiction is then caused to be displayed to a user on a display device. The techniques may be employed, for example, in the context of an online digital item retailer or in the context of a personal computing application to generate visual depictions of covers for digital items that users browse, purchase, download, access, or use.

### FIELD OF THE INVENTION

The present invention relates generally to data processing and, more particularly, to techniques in a data processor for generating a visual depiction of a cover for a digital item.

### BACKGROUND

Historically, retail items made available for purchase at retail establishments include some form of product packaging. Examples of such retail media items include books, magazines, Compact Discs (CDs) with recorded music, computer games, and movie Digital Versatile Discs (DVDs), etc. The packaging typically contains and protects the retail media item during its transportation from the manufacturer or supplier to the retailer and finally to the end consumer. In addition, the packaging also often serves an informational and advertising function at the retail establishment. For example, books displayed in book stores typically have book covers comprising artwork conveying information to consumers about the text inside. As another example, optical disc storage media made available for rental at movie rental stores typically are displayed in the rental stores in a protective casing covered with movie artwork conveying information to consumers about the content of the movie.

Today, many retail items that were previously only available for purchase in a physical form are now available for purchase in a digital form. For example, online digital media marketplaces exist where users can purchase digital items such as, for example, digital music, digital books, digital audio/video programs, and computer games. Newer types of digital items that have no direct physical retail item counterpart such as, for example, podcasts, webisodes, and webcasts, are also available for purchase through online digital marketplaces.

At the same time, there exist today many personal electronic devices capable of presenting digital media to users. Such personal computing devices include, for example, laptop and desktop computers, e-book readers, portable digital music players, tablet computing devices, notebook computers, smart phones, etc. As a result, consuming media in digital form has been growing in popularity and should continue to grow for the foreseeable future.

Many online digital marketplace operators aim to provide to their users a virtual shopping experience akin to retail shopping experiences the users may already be familiar with. For example, in a typical online “virtual store”, a user can browse digital items, add selected digital items to a virtual shopping cart, and checkout digital items for purchase. As part of providing this virtual shopping experience, online marketplace operators may wish to provide virtual packaging for the digital items that are “displayed” in their virtual stores. For example, an online book seller may wish to provide a virtual bookshelf that users can browse for digital books of interest or an online music seller may wish to provide a virtual record store in which users can browser for digital music of interest.

Many personal computing application and mobile application software developers may wish to provide software applications that allow users to browse and access their personal digital item libraries using a personal computing device in a manner akin to experiences users may be familiar with when browsing their physical media item libraries such as their book collections, CD collections, or DVD movie collections. For example, the online book seller may wish to provide a desktop, tablet, and/or mobile computing software application to users that allow users who purchase digital books from the online book seller to browse and access purchased digital books stored as part of their personal digital library.

### BRIEF DESCRIPTION OF THE DRAWINGS

FIG. 1 is a block diagram of a system environment including a cover generating system.

FIG. 2 is a block diagram of a system environment including a cover generating system.

FIG. 3 is a block diagram of a computer system upon which embodiments of the invention may be implemented.

FIG. 4 is a block diagram that illustrates a computer system 400 upon which an embodiment of the invention may be implemented

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

In accordance with some embodiments of the present invention, a system implementing techniques for generating a visual depiction of a cover for a digital item is provided. As used herein, a “digital item” may be any type of digital media content that can be presented to a user, including but not limited to visual content (e.g., pictures, slideshows, graphics, text, animation, etc.), audio content (e.g., music, speech, etc.), audio/visual content, also referred to as video content (e.g., movies, television shows, online programming, live events, etc.), interactive content (e.g., games, etc.), etc. Non-limiting examples of a digital item include a digital book, a digital music file, a computer game, a digital movie, etc.

According to one technique, the system receives item attribute metadata for the digital item. The item attribute metadata may be any information relating to the digital item. For example, the item attribute metadata may include some basic information about the digital item (e.g., title, author/creator, publisher, director, actor(s), etc.) as well as other information (e.g., how often the item has been used (e.g., read, viewed, played, etc.) by a particular user. The item attribute metadata may pertain to the digital item as a whole or to just a particular portion of the item.

After receiving the item attribute metadata, the system generates a base-depiction-selector-value, based on the item attribute metadata, using a mapping function. Specifically, the mapping function accepts values from one or more fields of the item attribute metadata as input, and provides a base-depiction-selector-value as output.

The specific fields of the attribute metadata whose values are used as input to the mapping function are referred to herein as the “target fields.” The target fields may be a relatively small subset of the fields for which attribute metadata is available for a given digital item.

For example, the attribute metadata for an electronic sound recording may contain dozens of fields, including time of recording, date of recording, length of recording, title of song, name of artist, sampling rate, etc. However, name of artist and title of song may be the only fields of the attribute metadata that are used to generate the base-depiction-selector-value for the sound recording. Under these circumstances, only “name of artist” and “title of song” would be target fields.

The target fields used to generate the base-depiction-selector-value may depend on the attribute metadata available for the digital item and hence, the type of the digital item. The mapping function may, for example, generate a base-depiction-selector-value for a digital book using the book's title and the author's name, and for a podcast using the podcast's creator's name and the date the podcast was created or published.

Using the base-depiction-selector-value generated by the mapping function, the system generates or determines a “base visual depiction” of a cover for the digital item. The final visual depiction used by devices to visually represent the digital item is based on the base visual depiction.

In some embodiments, the mapping function is deterministic. Under this circumstance, because the mapping function is deterministic, two digital items with identical values for all target fields may have the same base visual depiction. The deterministic nature of the mapping function increases the likelihood that different instances of essentially the same digital item will be assigned the same base visual depiction. For example, assume that the same artist recorded a particular song several times. Two different recordings of the same song may differ in a variety of ways, and those differences may be reflected in the attribute metadata of the respective recording. However, as long as song and title are the only two target fields, all recording of that song by that artist will be assigned the same base visual depiction.

### Visual Depictions of Digital Items

A visual depiction of a digital item can take the form of a digital image (e.g., TIFF, JPEG, PNG, etc.), computer-executable or computer application interpretable instructions for rendering the visual depiction (e.g, HTML, XHTML, Javascript, etc.), or a combination of a digital image and instructions.

In some embodiments, to determine the base visual depiction of a cover for the digital item, the system uses the base-depiction-selector-value to access a mapping table. In some embodiments, the mapping table associates the set of all possible base-depiction-selector-value values that can be generated by the mapping function to a set of base visual depiction items. Although not required, the number of possible base-depiction-selector-values may correspond to the number of base visual depiction items.

Each base visual depiction item includes data that can be used to generate a base visual depiction of a cover. A base visual depiction item may, for example, be a digital image (e.g., a TIFF, JPEG, GIF, PNG, etc). As another example, a base visual depiction item may indicate one or more visual properties of a digital image. For example, a base visual depiction item may specify a 24-bit RGB color value or a color value in any other color space used for computer graphics. As yet another example, a base visual depiction item may be a set of HTML instructions for rendering a base visual depiction of a cover in a web document such as a web page or any other information resource identifiable by a URI. As yet another example, a base visual depiction item may be a combination of a digital image and HTML instructions for rendering the digital image in a web document. These and other types of base visual depiction items will be elaborated upon in following sections.

### The Mapping Function

The mapping function projects target field values, from attribute metadata for the digital item, to a base-depiction-selector-value from a set of base-depiction-selector-values. The projection of target field values to base-depiction-selector-values may be many-to-one. For example, the mapping function may project virtually millions of possible target field values to a few hundred base-description-selector-values. Preferably, though not a requirement, the number of base-depiction-selector-values onto which the target field values are projected is sufficiently large so that a wide variety of different base visual depictions of a cover are possible. Thus, using the mapping function and the mapping table, the system can generate a base visual depiction of a cover for any digital item for which the target fields used by the mapping function are available.

In embodiments where the mapping function establishes a many-to-one relationship between target field values and base-depiction-selector-values, a base-depiction-selector-value collision can occur. A base-depiction-selector-value collision occurs when the mapping function produces the same base-depiction-selector-value for digital items that have different target field values. Preferably, though not a requirement, the mapping function generates each base-depiction-selector-value in the set of base-depiction-selector-values with equal or close to equal probability. In other words, the mapping function attempts to uniformly distribute the set of possible target fields over the set of base-depiction-selector-values. In some embodiments of the present invention, the mapping function applies a collision resistant cryptographic hash function (e.g., MD5, SHA1, SHA2, etc.) to given target fields. By attempting to achieve a uniform distribution, the probability that two different digital items will be represented by the same visual depiction of a cover is reduced. Example mapping functions that attempt to achieve a uniform distribution are described below.

### Generating the Final Visual Depiction

Once a base visual depiction of a cover has been determined for the digital item, in some embodiments, attribute metadata for the digital item is used to apply additional visual properties to the base visual depiction to produce a final visual depiction for the digital item. These additional visual properties may be additively applied to or combined with the base visual depiction to convey helpful information about the digital item to a viewer of the final visual depiction. For example, the base visual depiction may be given a weathered/used appearance corresponding to the age of the digital item, how often the digital has been used (e.g., read, viewed, played, etc.) by a user, or how often ownership of the digital item has been transferred. The additional visual properties that are applied may depend on the type of the digital item. For example, a base visual depiction of a digital book may be given a thickness appearance corresponding to the size of the book or the number of pages of the book. These and other types of additional visual properties will be elaborated upon in the following description.

### Digital Book Example

To illustrate how selecting a base visual image based on target field values may be used advantageously, reference will be made to the above example in which the digital item is a digital book. According to the technique, the system receives attribute metadata for the digital book including, in this example, values for the target fields of “author” and “title”. The mapping function of the system then generates a base-depiction-selector-value from the received target field values. In this example, the values for the target fields “author” and “title” are character strings. In this example, the mapping function generates the base-depiction-selector-value by calculating a fixed-length (e.g., 128-bit) MD5 hash value of the author string and the title string together (concatenated) and taking n number of low-order (or high order) bits of the hash value as the base-depiction-selector-value. Here, 2ⁿ (two to the power of n) equals the number of base visual depiction items in the mapping table. Use of the MD5 hash function or other cryptographic hash function that takes into account all the characters in the input character string provides collision resistance. This collision resistance is reduced where n is less than the number of bits of the fixed-length hash value produced by cryptographic hash function.

In this example, the mapping table includes 2ⁿ distinct base visual depiction items. Each base visual depiction item represents a different color through a 24-bit RGB color value (for 2ⁿ distinct colors). The system uses the base-depiction-selector-value generated by the mapping function to select a particular base visual depiction item, and hence a particular color, from the mapping table. To generate the base visual depiction of a cover, in this example, the particular color is applied to an x-pixel by y-pixel rectangular digital image (e.g., a JPEG, GIF, PNG, etc.) that represents a generic book cover. For example, the system may use a digital image editing library or module to set the color value of pixels of the image to the particular color value. In this way, a base visual depiction of a book cover is generated for the digital book that is visually distinguishable from other base visual depictions of book covers generated for different digital books.

Continuing the example, the system uses other values from the attribute metadata for the digital book to further distinguish the base visual depiction from other base visual depictions and to convey useful information about the represented digital book. For example, genre metadata for the digital book may be used to select a particular font for rendering the characters of the book title as an overlay to the base visual depiction. As another example, usage metadata for the digital book that indicates how often the digital book has been read/accessed by a user may be used to give a corresponding worn cover appearance (e.g., cover appears more weathered/worn, edges of cover are more torn or blunted, etc. as usage increases). As yet another example, genre metadata for the digital book may be used to select a texture for the visual depiction (e.g., visual depictions of classic novels have a dusty library book appearance while visual depictions of mystery novels have a dime store novel appearance).

In this example, the system is capable of generating 2ⁿ distinct base visual depictions from a single digital image “template”. Thus, the system need not store or have access to 2ⁿ digital images in order to generate the 2ⁿ distinct base visual depictions of a cover. This is beneficial where data storage space is limited. For example, a user may wish to browse his/her digital book library stored on his/her portable e-book reader device. In this case, storing 2ⁿ digital images or a digital image for each digital book in the library on a storage device of the reader consumes precious storage space that could otherwise be allocated to storing digital books. Thus, the system can be advantageously used to generate distinct visual depictions of covers for digital items while at the same time minimizing the storage “footprint” on e-book readers, portable music players, smart phones, tablet computers, or any other computing device with a fixed storage capability.

Also in this example, the system, by virtue of the mapping function and mapping table, is capable of consistently generating the same or a consistent visual depiction of a cover for the digital book. Thus, the system may be employed on multiple devices or systems to consistently generate the same or a consistent visual depiction of a cover for digital book. For example, the system may be employed in the context of an online book seller application to generate a visual depiction of a cover for the digital book when offered for purchase and download from the online book seller. After a user purchases and then downloads the digital item from the booker seller to a personal computing device, the system may be employed on the user's personal computing device to generate a visual depiction of a cover for the digital book in the user's personal digital library that is consistent with or the same as the visual depiction generated by the online book seller.

The above discussion provides a general overview of some embodiments of the present invention. In the following sections, one or more possible implementations will be described in detail.

### System Environment Overview

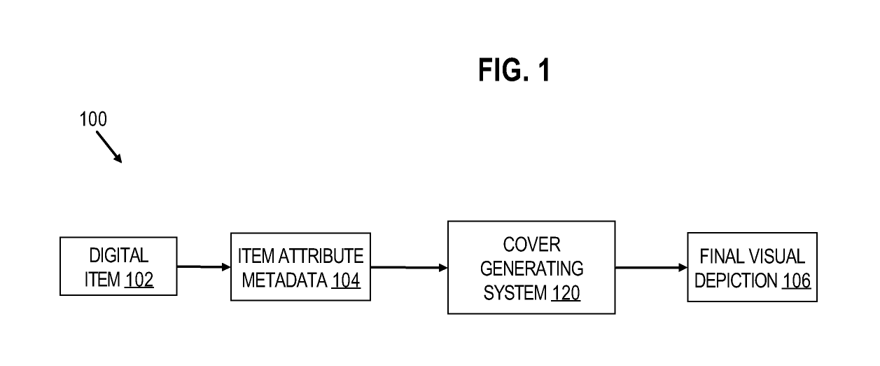

With reference to FIG. 1, there is shown a block diagram of a system environment 100 in which some embodiments of the present invention may be implemented. As shown, the system environment 100 comprises a digital item 102, attribute metadata 104 for the digital item 102, a cover generating system 120, and a final visual depiction 106 of a cover for the digital item 102 generated by the cover generating system 120 based on the input attribute metadata 104. Specifically, final visual depiction 106 is generated by modifying a base visual depiction (determined by target field values from attribute metadata 104) based on other values from the attribute metadata 104.

The digital item 102 may be any type of digital media content that can be presented to a user, including but not limited to visual content (e.g., pictures, slideshows, graphics, text, animation, etc.), audio content (e.g., music, speech, etc.), audio/visual content, also referred to as video content (e.g., movies, shows, live events, etc.), interactive content (e.g., games, etc.), etc. Non-limiting examples of the digital item 102 include a digital book, a digital music file, a computer game, a digital movie, etc. The digital item 102 may one of a library or collection of digital items. For example, the library may be a collection of digital music files stored on a storage device of the user's portable music player or a collection of digital book files stored on a storage device of the user's e-book reader. As another example, the library may be a collection of files (e.g., music files, book files, computer game files, etc.) stored on a network accessible server and made available for download.

The attribute metadata 104 may be any information relating to the digital item 102. For example, the attribute metadata 104 may include some basic information about the digital item 102 (e.g., title, author/creator, publisher, director, actor(s), etc.) as well as other information (e.g., how often the item has been used (e.g., read, viewed, played, etc.) by a particular user). The attribute metadata 104 may pertain to the digital item 102 as a whole or to just a particular portion of the item 102.

The final visual depiction 106 may be any type of digital content that can be visually presented to a user including, but not limited to, digital images (e.g., TIFF, JPEG, GIF, PNG, etc.) and digital video (e.g., MPEG-2, MPEG-4, etc.), any type of computer-executable or computer application-interpretable instructions which, when executed or interpreted, causes a visual presentation to the user including but not limited to interactive graphics instructions (e.g., Abode® Flash®, HTML 5, etc.), or a combination of digital content and computer-executable or computer application interpretable instructions.

The cover generating system 120 receives (obtains) as input the target field values of attribute metadata 104 and produces as output, based on the target field values, the final visual depiction 106 of a cover for the digital item 102. In some embodiments of the present invention, the system 120 is implemented in software. However, the system 120 may be implemented entirely in hardware or a combination of hardware and software.

In some embodiments, the system 120 is a software component, sub-module, or sub-routine of an online web application. In this context, the system 120 is used to generate final visual depictions 106 of covers for digital items 102 that are to be represented in a web document. The web document may be presented to a user using a web browsing application or other computing application capable of presenting (rendering) web documents. In this description, the term “browser” refers broadly to any computing application for presenting web documents (e.g., HTML documents, XHTML documents, XML documents, etc.) to a user.

The browser may, for example, execute on the user's personal computing device such as a personal computer, laptop computer, tablet computer, smart phone, etc. The final visual depictions 106 may be sent by the online web application over a data network (e.g., the Internet) to users' browsers along with other data (e.g., HTML instructions) for rendering web documents containing the final visual depictions 106.

In some embodiments in which the system 120 is a software component, sub-module, or sub-routine of an online web application, the system 120 is implemented in server software operating in an Internet-connected environment running under an operating system, such as Microsoft Windows®, UNIX®, Mac OS®, Linux®, etc.

In some embodiments, the system 120 is a software component, sub-module, or sub-routine of a personal computing application. Non-limiting examples of a personal computing application include desktop applications, mobile applications, or any other application software that executes on a personal computing device. Personal computing devices include but are not limited to desktop computers, laptop computers, e-book readers, portable digital music players, computer gaming consoles, set-top devices, tablet computers, personal digital assistants, etc. The system 120 may be pre-installed by the manufacturer or reseller of the personal computing device or may be downloaded over a data network to the personal computing device and installed on the personal computing device by a user. In this context in which the system 120 is a software component, sub-module, or sub-routines of a personal computing application, the system 120 is invoked (called) as a component, sub-module, or sub-routine of the personal computing application to generate visual depictions 106 of covers for digital items 102 that are to be presented on a display device operatively coupled to the personal computing device. The display device may be any output device for electronically presenting information in a visual form such as, for example, a television set, computer monitor, etc.

One example of a personal computing application that might invoke (call) the system 120 to generate visual depictions 106 of covers for digital items 102 is a graphical user interface-based application that allows a user to browse or use (e.g., read, view, play, etc.) digital items stored in his or her personal digital library. The personal digital library might, for example, be a collection of digital music files or digital book files stored on a data storage device of the user's personal computing device or on a data storage device accessible (operatively coupled) to the user's personal computing device. In this context, existing visual depictions of covers for the digital items might not be available. For example, if the user created digital copies of his/her CD music collection, then the digital copies (digital items) might not be associated with any cover artwork or other visual depiction of a cover. In this context, the system 120 could be used to generate visual depictions of covers for the digital items in the user's personal digital library.

In some embodiments in which the system 120 is a software component, sub-module, or sub-routine of a personal computing application, the system 120 is implemented in desktop application or mobile application software operating running under an operating system, such as Microsoft Windows®, UNIX®, Mac OS®, Linux®, etc.

The above-described environments are presented for purpose of illustrating exemplary system environments in which the cover generating system of the present invention may be implemented. The present invention, however, is not limited to any particular environment or computing device configuration and the cover generating system of the present invention may be implemented in any type of system or processing environment capable of supporting the techniques for generating a visual depiction of a cover for a digital item as presented herein.

### Cover Generating System Detailed Operation

The following discussion will focus on the generation of a final visual depiction 106 of a cover for a single digital item 102 by a cover generating system 120. However, it should be understood that the system 120 can be used to generate multiple final visual depictions 106 for multiple different digital items 102 either serially (one at a time) or in parallel (many at a time). Further, the system 120 can be used to generate final visual depictions 106 in an offline or online context or in the context of a user request or outside the context of a user request. For example, the system 120 can be used to generate final visual depictions 106 for an entire library of digital items in an offline pre-processing phase. The system 120 can also be used to generate final visual depictions 106 of digital items in response to a user request.

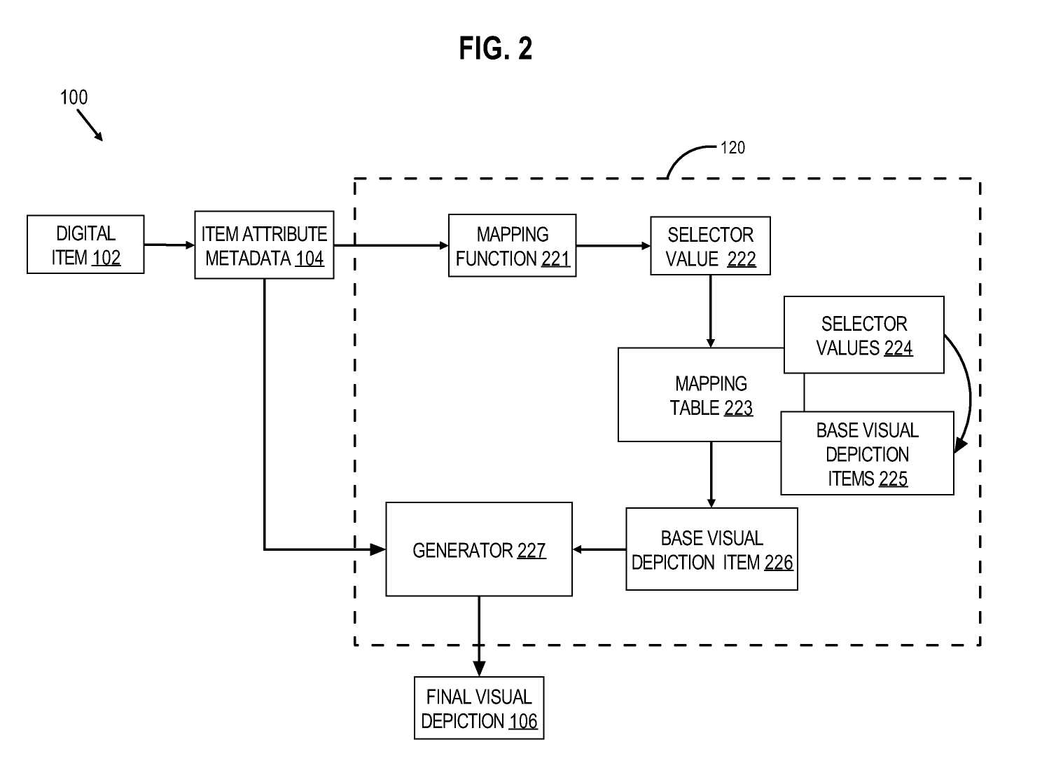

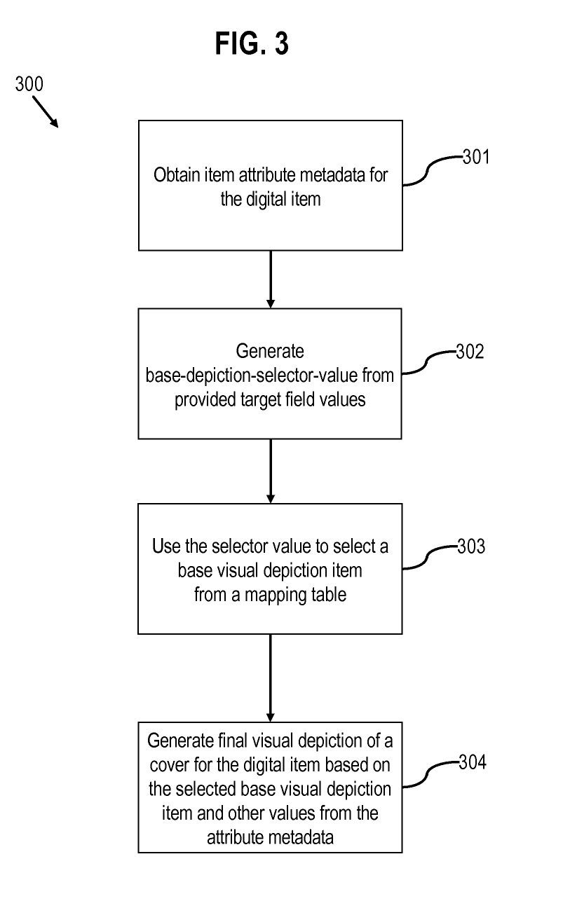

Before describing components of the system 120 for generating a final visual depiction 106 of a cover for a digital item 102, the general method for generating a final visual depiction 106 of a cover for a digital item 102 will be described with reference to FIG. 2 and FIG. 3. FIG. 2 illustrates the environment 100 of FIG. 1 including the cover generating system 120 of FIG. 1 in greater detail. FIG. 3 illustrates a method 300 for generating a final visual depiction 106 of a cover for a digital item 102 in the cover generating system 120.

The method steps may be implemented using processor-executable instructions, for directing operation of one or more computing devices under processor control. The processor-executable instructions may be stored on a non-transitory computer-readable medium, such as hard disk, CD, DVD, flash memory, or the like. The processor-executable instructions may also be stored as a set of downloadable processor-executable instructions, for example, for download and installation from an Internet location (e.g., a web service).

According to some embodiments, the method 300 generally operates as follows. At step 301, attribute metadata 104 for the digital item 102 is obtained by the system 120. From the attribute metadata 104, the target field values are provided to a mapping function 221 by the system 120.

At step 302, the mapping function 221 generates a base-depiction-selector-value 222 from the target field values provided to it.

At step 303, the system 120 uses the base-depiction-selector-value 222 generated by the mapping function 221 to select a base visual depiction item 226 in a mapping table 223 which maps base-depiction-selector-values 224 to a set of base visual depiction items 225. The selected base visual depiction item 226 is then provided to a generator 227.

At step 304, the generator 227 generates a final visual depiction 106 of a cover for the digital item 102 based on the selected base visual depiction item 226 and other values from the attribute metadata 104.

### Attribute Metadata

The attribute metadata 104 may be any information relating to the digital item 102. For example, the attribute metadata 104 may include some basic information about the digital item 102 (e.g., title, author/creator, publisher, director, actor(s), etc.) as well as other information (e.g., how often the item has been used (e.g., read, viewed, played, etc.) by a particular user). The attribute metadata 104 may pertain to the digital item 102 as a whole or to just a particular portion of the item 102. Examples of fields within attribute metadata 104 that apply to only portions of item 102 include, for example, the titles of chapters, the authors of different sections of a collective work, etc. The target fields that are used to generate the base-depiction-selector-value for an item may include fields that relate to the entire item, fields that relate to only portions of the item, or both.

Attribute metadata 104 may be stored in one or more databases, one or more files, or one or more other suitable data storage containers where it can be accessed by (obtained by) the system 120 or accessed by another component (not shown) that provides the attribute metadata 104 to the system 120 as input. The data format of the attribute metadata 104 can be varied. Generally, the attribute metadata 104 is treated by the system 120 as one or more sequences of bytes representing character strings, numbers, or abstract data types. Typically, though not required, attribute metadata 104 will be formatted as one or more character strings such as one or more UNICODE character strings or one or more ASCII character strings. The character strings themselves may be encoded using a multi-byte character encoding scheme (e.g., UTF-8).

The attribute metadata 104 available for the digital item 102 is expected to vary depending on the type of the digital item 102. For example, a digital book item 102 will likely have attribute metadata 104 that is different than the attribute metadata 104 for a digital music item 102. As an example, the attribute metadata 104 for a digital book item 102 may include: title, author, publisher, form (e.g., novel, poem, drama, short story, novella, magazine, periodical, newspaper, etc.), genre (e.g., epic, lyric, drama, romance, satire, tragedy, comedy, etc.), size (e.g., number of pages, number of words, etc.), publication date, classification identifier (e.g., ISBN number), and usage information (e.g., how many times the digital book has been read/accessed by a user). As another example, the attribute metadata 104 for a digital music item 102 may include: song title, artist, producer, release date, audio encoding format (e.g., MP3, AIFF, WAV, MPEG-4, AAC, etc.), musical category (e.g., pop, alternative, blues, classical, etc.), and usage information (e.g., how many times the digital music item has been played by a user). These are but some examples of possible attributes of a digital item 102 that may be used as target fields, and the techniques described herein are not limited to digital music items or digital book items or the item attributes described above.

### Mapping Function And Mapping Table

After obtaining the attribute metadata 104, the system 120 invokes (calls) the mapping function 221 providing the target field values as input to the mapping function 221. The mapping function produces a base-depiction-selector-value 222 as output. In some embodiments, the mapping function 221 implements a many-to-one mapping in which the number of possible input target field values is vastly greater than the number of base-depiction-selector-values 222 to which the target field values are mapped. Once the mapping function 221 has produced a base-depiction-selector-value 222, the system 120 uses the base-depiction-selector-value 222 to access a mapping table 223 that associates the base-depiction-selector-values 224 with a set of base visual depiction items 225. The system 120 uses the base-depiction-selector-value 222 to access the mapping table 223 and select a base visual depiction item 226 from amongst the set of base visual depiction items 225.

Any number of different strategies may be used for projecting the set of possible input target fields to the set of possible base-depiction-selector-values 224. Examples of possible projection strategies will now be described.

### A FIRST EXAMPLE PROJECTION STRATEGY

A first projection strategy may be employed where the system 120 confines the set of all possible target field values for the digital item 102 to a relatively small set. Under this strategy, the system 120 uses the input target field values directly in generating the base-depiction-selector-value 222. In other words, the base-depiction-selector-value 222 is constructed using the input target field values themselves, and there is identity between the set of all possible input target field values as defined (confined) by the system 120 and the set of base-depiction-selector-values 224 in the mapping table 223. Thus, how small the set must be is a function of available storage space (memory) for storing the set of base-depiction-selector-values 224 of the mapping table 223.

For example, in some embodiments in which the digital item 102 is a digital book, the mapping function 221 generates a base-depiction-selector-value 222 by concatenating the first character of the author's name to the last character of the book's title. Using the last character of the title instead of the first character of the title helps to avoid common base-depiction-selector-value collisions where titles for different digital books begin with the same word or phrase (e.g., “A”, “The”, “An”, etc.). For example, the base-depiction-selector-value 222 under this strategy for “The Illiad” by “Homer” would be “HD” instead of “HT” and the base-depiction-selector-value 222 for “The Odyssey” by “Homer” would be “HY” instead of also being “HT”. Assuming that each character in the author metadata and the title metadata is represented by an 8-bit value (e.g., as in the ASCII or ISO Latin-1 character set), the set of possible target field values has at most 256² (65,536) members. This number can be reduced if only printable ASCII characters are used (96²=9,216). Or reduced even further if just the uppercase letters A-Z are used (26²=676). Thus, in this example, the possible number of base-depiction-selector-values 224 ranges from 676 to 65,536.

### A SECOND EXAMPLE PROJECTION STRATEGY

A second projection strategy may be applied more generally regardless of the number of members in the set of possible input target field values for the digital item 102. In this second strategy, a cryptographic hash function is applied to the target field values to produce a fixed length (x-bit) hash value. The number of bits of the hash value x typically ranges from 32 to 128 but may be larger or smaller. Virtually any cryptographic hash function that accepts an arbitrary block of data and returns a fixed size bit string may be used. Preferably, though not required, the cryptographic hash function is deterministic and is collision resistant. Non-limiting examples of suitable cryptographic hash functions include MDS, SHA-1, SHA-2, etc.

Next, after the hash value has been generated, n number of bits of the x-bit hash value are selected as the base-depiction-selector-value 222 (e.g., the n most significant or the n least significant bits of the x-bit hash value). Here, n is selected as function of the number of visual depiction items 225. In particular, n is selected such that 2ⁿ is equal to or greater than the number of base visual depiction items 225. Thus, when employing this second projection strategy, the mapping function 221 can produce 2ⁿ distinct base-depiction-selector-values 224 each of which correspond in the mapping table 223 to at least one of up to 2ⁿ base visual depiction items 225. Note that where there are less than 2ⁿ base visual depiction items 225 in the mapping table 223 some base-depiction-selector-values 224 will map to more than one base visual depiction item 225.

### A THIRD EXAMPLE PROJECTION STRATEGY

In a variation on the second projection strategy, instead of using n number of bits of the x-bit hash value as the base-depiction-selector-value 222, the base-depiction-selector-value 222 is computed as the reminder of the x-bit hash value when divided by m, where m is the number of base-depiction-selector-values 224 in the mapping table 223 (i.e., base-depiction-selector-value=x-bit hash value modulo m). In this variation, the mapping table 223 can be assured to have no more base-depiction-selector-values 224 than there are base visual depiction items 225.

### A FOURTH EXAMPLE PROJECTION STRATEGY

In some embodiments, a stable projection strategy is used to minimize the change to the mapping between given input target fields and a base visual depiction item 225 when a base visual depiction item 225 is added to or removed from the mapping table 223. This strategy prevents user confusion that would result if the visual depiction of a cover for a particular digital item were to change between user viewing s as a result of re-mapping base-depiction-selector-values 224 to base visual depiction items 225 in the mapping table 223 to accommodate a new base visual depiction item 225 to the mapping table 223 or to accommodate removal of a base visual depiction item 225 from the mapping table 223. This strategy cannot prevent all re-mapping but it can be used to minimize the impact adding or removing a base visual depiction item 225 has on the mapping.

Very generally, in this example stage projection strategy, each of the base-depiction-selector-values 224 represents a sub-range of a circular range of possible hash values that can be returned by a particular cryptographic hash function used by the mapping function 221. Conceptually, the circular range is defined by mapping the range of possible hash values that can be returned by the particular hash function to a circle such that each possible hash value is a point along the circumference of the circle and each point along the circumference of the circle proceeding in a direction (e.g., clockwise) represents the next increasing value in the range of possible hash values until the highest possible hash value is reached at which point the circular range “wraps-around” to the lowest possible hash value. For example, if a particular cryptographic hash function returns 2³² possible hash values (i.e., a 32-bit hash value), then the circular range might range from 0 to 2³²−1 wrapping around back to 0 at 2³²−1.

In this stable projection strategy, each base visual depiction item 225 in the set of base visual depictions items 225 is mapped to a value in the circular range by applying the particular cryptographic hash function to the base visual depiction item 225. This value is represented as a base-depiction-selector-value 224 in the mapping table 223 and the base-depiction-selector-value 224 is associated with the base visual depiction item 225. Values in the circular range corresponding to two consecutive base-depiction-selector-values 224 define a sub-range of the circular range. A base-depiction-selector-value 222 is generated by the mapping function 221 from target field values by applying the particular cryptographic hash function to the input target field values to produce a hash value for the input target field values. A base visual depiction item 226 is selected for the base-depiction-selector-value 222 by determining which sub-range defined by two consecutive base-depiction-selector-values 224 the generated base-depiction-selector-value 222 falls into. Once the sub-range has been determined, one or the other of the base visual depiction items 225 associated with the two consecutive base-depiction-selector-values 224 that define the sub-range is selected as the base visual depiction item 226 for the particular base-depiction-selector-value 222. Conceptually, which of the two base visual depiction items 225 associated with the two consecutive base-depiction-selector-values 224 is selected is a matter of proceeding in a clockwise direction or a counter-clockwise direction along the circumference of the circle defining the circular range starting at a point in the sub-range corresponding to the hash value of the input target fields until the first mapping value corresponding to one of the two consecutive base-depiction-selector-values 224 is encountered. Which of the two base visual depiction items 225 associated with the two consecutive base-depiction-selector-values 224 is selected as the base visual depiction item 226 is arbitrary, and either one may be selected so long as a consistent approach is used (e.g., always proceeding in the clockwise direction).

### Adding a New Base Visual Depiction Item

When a new base visual depiction item is added to the set of base visual depiction items 225, the new base visual item 225 is mapped to a value in the circular range by applying the particular cryptographic hash function to the new base visual depiction item 225. This value is represented as a new base-depiction-selector-value 224 in the mapping table 223 and the new base-depiction-selector-value 224 is associated with the new base visual depiction item 225 thereby sub-dividing an existing sub-range of the circular range defined by two formerly consecutive base-depiction-selector-values 224.

### Removing a Base Visual Depiction Item

When a base visual depiction item 225 is removed from the set of base visual depiction items 225, the base-depiction-selector-value 224 for the removed base visual depiction item is removed from the set of base-depiction-selector-values 224 in mapping table 223 thereby creating a new sub-range defined by the now consecutive base-depiction-selector-values 224 that were formerly consecutive with the removed base-depiction-selector-value.

Assuming a cryptographic hash function that provides a “random” distribution of base visual depiction items 225 and input target fields over the possible hash value range, this stable projection strategy reduces the impact relative to other projection strategies that changing the set of base visual depiction items 225 in the mapping table 223 has on the existing mapping between base-depiction-selector-values 224 and base visual depiction items 225 and hence, reduces the possibility that the base visual depiction item 226 selected for a given digital item 102 will change after a base visual depiction item is added to or removed from the set of base visual depiction items 225 in the mapping table 223. Virtually any collision resistant cryptographic hash function that accepts an arbitrary block of data and returns a fixed-sized bit string may be used to provide this “random” distribution (e.g., MDS, SHA-1, SHA-2, and the like).

### Other Projection Considerations

In the above example projection strategies, input target fields for a given digital item 102 is used by the mapping function 221 to generate a base-depiction-selector-value 222 for the given digital item 102. Ideally, though not a requirement, the input target fields for the given digital item 102 that is used by the mapping function 221 to generate the base-depiction-selector-value 222 is invariant. That is, the input target field values do not change over the life of the digital item 102. Thus, the attribute metadata 104 of the given digital item 102 that is used by the mapping function 221 as the input target fields may vary depending on the type of the given digital item 102. For example, if the given digital item 102 is a digital book, then appropriate invariant target fields might include the book title and the book author. As another example, if the given digital item 102 is a digital music item, then appropriate invariant target fields might include the music title and artist.

In some embodiments, each digital item 102, regardless of type, is assigned an invariant digital item identifier (e.g., a multi-byte character string) that is used as a target field value by the mapping function 221 to generate the base-depiction-selector-value 222 for the digital item 102. Similarly, when a stable projection strategy is employed, the input to the cryptographic hash function when generating a hash value for a particular base visual depiction item 225 should be invariant with respect to that particular base visual depiction item 225. Invariant identifiers may be assigned to each base visual depiction item 225 for this purpose.

In some embodiments, input to the mapping function 221 and cryptographic hash functions is canonicalized or normalized by the system 120 before being provided as input. This canonicalization or normalization is performed to prevent semantically un-meaningful differences between different attribute metadata 104 for the same digital item 102 from causing different base visual depiction items 226 being selected for the digital item 102. For example, the input may be stripped of whitespace, characters converted into all lowercase or all uppercase, punctuation removed, words stemmed, etc.

Further, the term “table” as used in the context of the mapping table 223 is meant to refer broadly to a data association between the set of base-depiction-selector-values 224 and the set of base visual depiction items 225 and is not meant imply any particular data structure for implementing the data association. For example, mapping table 223 may be implemented as an associative array or a binary or n-ary tree in which each node in the tree corresponds to a base-depiction-selector-value 224. Other data structure implementations are possible and the present invention is not limited to any particular data structure implementation.

Further, the above-described example projection strategies are presented for purpose of illustrating exemplary projection strategies for projecting the set of possible input target fields to a set of base-depiction-selector-values. The present invention, however, is not limited to the example projection strategies discussed above and other projection strategies that provide at least a deterministic projection may be used. A deterministic projection means that for given target fields that same base-depiction-selector-value is always produced.

### Base Visual Depiction Item

As mentioned above, a base visual depiction item 226 of a cover has been selected for digital item 102 based on the digital item's target field values. In some embodiments, the base visual depiction item 226 is digital content that can be visually presented to a user, such as a digital image (e.g., TIFF, JPEG, GIF, PNG, etc.). In some embodiments, the base visual depiction item 226 is a set of one or more visual properties of a digital image to be created or to be applied to a “template” digital image. For example, a base visual depiction item may simply be data that represents a particular color.

In some embodiments, the base visual depiction item 226 is a set of computer-executable or computer application-interpretable instructions which, when executed or interpreted, causes a visual presentation to the user. For example, the base visual depiction item 226 may be a set of interactive graphics instructions (e.g., Abode® Flash®, HTML 5, etc.) which, when executed or interpreted in the context of an executing browser application, causes a visual depiction of a cover to be rendered in a web document. In some embodiments of the present invention, the base visual depiction item 226 is a combination of digital content, visual properties, and computer-executable or computer application interpretable instructions.

### Digital Image of a Base Visual Depiction of a Cover

In some embodiments, the base visual depiction item 226 includes a digital image representing a base visual depiction of a cover. For example, the digital image may represent a generic book cover or a generic album cover. In some embodiments of the present invention, the digital image has at least one visual property (e.g., color) that visually distinguishes the cover from other covers represented by other base visual depiction items 225. The digital image may be encoded using a lossy or lossless encoding format such as, for example, TIFF, PNG, JPEG, GIF, etc.

### Visual Properties of a Digital Image of a Base Visual Depiction of a Cover

In some embodiments, the base visual depiction item 226 includes a set of one or more visual properties. In this case, the base visual depiction item 226 may include data representing the visual properties. The data representing the visual properties can be used to create a digital image with the visual properties or applied to an existing “template” digital image. This template digital image may be specified as part of base visual depiction item 226 or specified by another part of the system 120 (not shown). The visual properties may be applied to the template digital image or used to create the digital image that represents a visual depiction of cover using a digital image editing software library or other computer algorithms for altering, generating, or editing digital images.

The data of the base visual depiction item 226 representing the visual properties will vary depending on the type of visual properties. For example, the data may include one or more color values such as a one or more RGB color values representing the color or colors of the digital image. As another example, the data may include a size value representing the size of the digital image (e.g., how the template digital image is to be cropped or resized).

### Instructions for Rendering a Base Visual Depiction of a Cover

In some embodiments, the base visual depiction item 226 includes a set of computer-executable or computer application-interpretable instructions which, when executed or interpreted, causes a visual presentation to the user. For example, a base visual depiction item 226 may include a set of HTML instructions for rendering a base visual depiction of a cover in a web document. As another example, a base visual depiction item 226 may be a combination of a digital image and HTML instructions for rendering the digital image in a web document. As yet another example, a base visual depiction item 226 may include a set of vector graphics drawing instructions for drawing a visual depiction of a cover on a vector graphics drawing surface. For example, in one embodiment, the vector graphics drawing surface is a HTML 5 Canvas and the vector graphics drawing instructions are instructions for drawing a visual depiction of a cover on the HTML 5 Canvas.

### Generating a Distinctive and Informative Visual Depiction of a Cover

In most cases, the base visual depiction item 226 selected for the given digital item 102 will not include information for visually distinguishing the digital item 102 from other digital items for which the mapping function 221 generates the same base-depiction-selector-value 222. Accordingly, in some embodiments, the generator module 227 uses attribute metadata 104 (or a portion thereof) of the given digital item 102 to produce a final visual depiction 106 of a cover for the given digital item 102 that is more distinctive and more informative that the selected base visual depiction.

The final visual depiction 106 may be any type of digital content that can be visually presented to a user including but not limited to a digital image (e.g., a TIFF, JPEG, GIF, PNG, etc.), any type of computer-executable or computer application-interpretable instructions which, when executed or interpreted, causes a visual presentation to the user including but not limited to interactive graphics instructions (e.g., Abode® Flash®, HTML, etc.), or a combination of digital content and computer-executable or computer application interpretable instructions.

In some embodiments, the final visual depiction 106 visually distinguishes the given digital item 102 from other digital items for which the mapping function 221 generates the same base-depiction-selector-value 222. In addition, the final visual depiction 106 may include information for visually conveying informative properties or attributes of the given digital item 102 to a viewer of the final visual depiction 106.

Any number of different techniques may be used by the generator 227 to generate a distinctive and informative final visual depiction 106 of a cover for the digital item 102 from the selected base visual depiction item 226. The techniques uses may vary depending on the type of the selected base visual depiction item 226. For example, if the selected base visual depiction item 226 is a digital image, then additional visual properties may be applied to the digital image using image editing techniques. Such image editing techniques may include adding textual overlays, cropping the image, layering one or more other images on the image, resizing the image, re-coloring the images, etc. If the selected base visual depiction item 226 includes data representing visual properties to apply to a digital image, then additional visual properties may be applied to the digital image using image editing techniques. If the selected base visual depiction item 226 includes instructions for rendering a visual depiction of a cover, then additional visual properties may be applied to the selected base visual depiction by adding, replacing, or modifying the instructions. A combination of different techniques may be used as well.

### Text Overlay

In some embodiments, the final visual depiction 106 includes a text overlay. The text of the text overlay may be based on the attribute metadata 104 for the digital item 102 or a portion thereof. For example, the text overlay for a digital book item might include the book's title and the author's name. The text overlay for a digital music item might include a song title or the artist's or producer's name, for example.

### Genre Metadata

In some embodiments, the font of the text in the text overlay in the final visual depiction 106 is selected by the generator 227 based on genre metadata available for the digital item 102. In this context, genre metadata refers broadly to any metadata that indicates a class, type, or category of the digital item 102. For example, for a digital book item 102, the genre metadata may indicate a category of literature. For a digital music item 102, the genre metadata may indicate a form of music, for example. The selected font may be representative of the genre. The generator 227 may maintain a mapping or lookup table associating genres and fonts. The generator 227 consults the mapping or lookup table using the genre metadata to identify a font in which text of the text overlay is to be rendered.

In some embodiments, genre metadata is used by the generator 227 to provide a stylized appearance to the visual depiction of a cover. The style that is selected may be appropriate for the genre. For example, the final visual depiction 106 of a cover for a digital book item 102 corresponding to a classic novel may be given a dusty book cover appearance. As another example, the final visual depiction 106 of a cover for a digital book item 102 corresponding to a mystery novel may be given a dime store novel appearance. Other styles are possible and may vary depending on the type of the digital item 102.

### Usage Metadata

In some embodiments, usage metadata for the digital item 102 is used by the generator 227 to provide a used/worn appearance to the visual depiction of a cover corresponding to how often the digital item 102 has been used (e.g., read, viewed, played, etc.) by a user. The usage metadata may be any data reflecting an amount of usage of the digital item 102 by a user. For example, the usage metadata may indicate how often the digital item 102 has been read, if a digital book or played, if a digital music item or a computer game. The extent of the used/worn appearance (i.e., how used/worn the visual depiction of the cover appears) may correspond to the extent of usage of the digital item 102 as indicated by the usage metadata. For example, the visual depiction of a cover for a digital book item 102 that has been read only a relatively few number of times might appear with slightly worn edges while the visual depiction of a cover for a digital book item 102 that been read numerous times might appear to have a slightly torn or heavily worn cover.

### Size Metadata

In some embodiments, size metadata for the digital item 102 is used by the generator 227 to provide an appearance to the visual depiction of a cover that visually conveys the size of the content of the digital item 102. For example, a digital book item 102 may be given a thickness appearance corresponding to the number of pages of the digital book item. As another example, the final visual depiction 106 of a digital picture book item 102 may appear larger than the final visual depiction 106 of a digital paperback book item 102.

The above example metadata provide just a few examples of how target fields for a digital item may be used to generate a descriptive and informative visual depiction of a cover for the digital item. Many other variations are possible, and are within the scope of the present invention.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

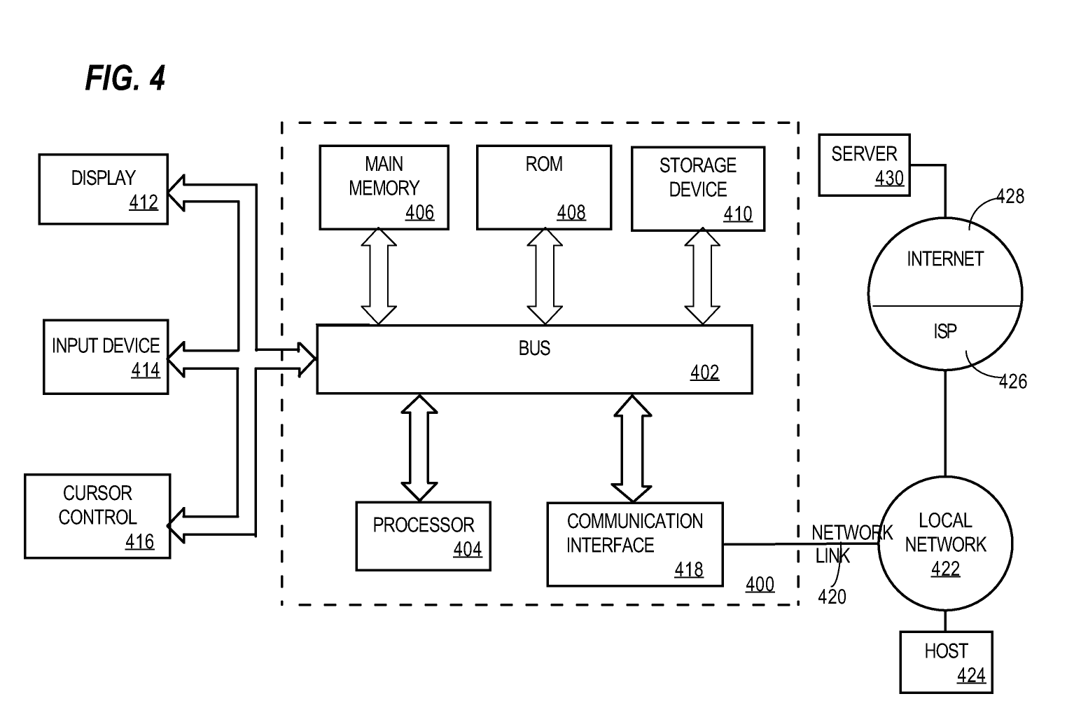

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### Extensions and Alternatives

In the foregoing specification, embodiments of the present invention have been described with reference to numerous specific details that may vary from implementation to implementation. Thus, the sole and exclusive indicator of what is the invention, and is intended by the Applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising:
obtaining one or more values from attribute metadata pertaining to a digital item;
generating a base-depiction-selector-value based on at least a portion of the one or more values;
accessing a mapping table to select a base visual depiction item using the base-depiction-selector-value;
generating a visual depiction to visually represent the digital item based, at least in part, on the selected base visual depiction item; and
causing display of the visual depiction on a display device;
wherein the method is performed by one or more computing devices.

2. The method of claim 1, further comprising:
determining one or more visual properties for the visual depiction based on at least one value, from the attribute metadata pertaining to the digital item, other than the one or more values;
generating the visual depiction for the digital item based least in part on the selected base visual depiction item and the one or more determined visual properties; and
causing display of the visual depiction on the display device with the one or more determined visual properties.

3. The method of claim 2, wherein:
determining the one or more visual properties includes determining a text overlay for the visual depiction based on the at least one value; and
causing display of the visual depiction includes causing display of the visual depiction on the display device with the text overlay.

4. The method of claim 3, wherein:
the digital item is a digital book; and
determining the text overlay includes determining the text overlay based on one or both of title metadata and author metadata pertaining to the digital book.

5. The method of claim 2, wherein determining the one or more visual properties includes determining a style for the visual depiction based on genre metadata pertaining to the digital item; and wherein causing display of the visual depiction includes causing display of the visual depiction on the display device according to the style.

6. The method of claim 2, wherein determining the one or more visual properties includes determining a used/worn appearance for the visual depiction based on usage metadata pertaining to the digital item; and wherein causing display of the visual depiction includes causing display of the visual depiction on the display device with the used/worn appearance.

7. The method of claim 6, wherein the extent of the used/worn appearance is based on the amount of usage of the digital item according to the usage metadata.

8. The method of claim 1, wherein generating the base-depiction-selector-value includes invoking a mapping function to generate the base-depiction-selector-value based on the one or more values.

9. The method of claim 6, wherein invoking the mapping function to generate the base-depiction-selector-value includes invoking a cryptographic hash function providing the one or more values to produce the base-depiction-selector-value.

10. The method of claim 1, wherein the mapping table associates a set of base-depiction-selector-values with a set of base visual depiction items.

11. The method of claim 1, wherein the base visual depiction item includes a digital image.

12. The method of claim 1, wherein the base visual depiction item includes a set of visual properties of a digital image.

13. The method of claim 12, wherein the set of visual properties includes an RGB color value.

14. The method of claim 1, wherein the base visual depiction includes one or more sequences of instructions for rendering a visual depiction.

15. The method of claim 14, wherein the one or more sequences of instructions includes HTML or XHTML instructions for rendering a visual depiction.

16. The method of claim 1, wherein the digital item is a digital book, a digital music item, or a computer game.

17. A method comprising:
obtaining one or more values from attribute metadata pertaining to a digital item;
obtaining an initial digital image representing an initial visual depiction for the digital item;
determining one or more visual properties for a final digital image representing a final visual depiction for the digital item based on at least the one or more values;
generating the final digital image based at least on the initial digital image and the one or more determined visual properties; and
causing display of final digital image on the display device as a visual depiction for the digital item;
wherein the method is performed by one or more computing devices.

18. The method of claim 17, wherein determining the one or more visual properties includes determining a text overlay for the final digital image based on the one or more values; and wherein causing display of the visual depiction includes causing display of the final digital image with the text overlay.

19. The method of claim 18, wherein the digital item is a digital book; and wherein determining the text overlay includes determining the text overlay based on one or both of title metadata and author metadata pertaining to the digital book.

20. The method of claim 17, wherein determining the one or more visual properties includes determining a style for the final digital image based on genre metadata pertaining to the digital item; and wherein generating the final digital image includes layering the initial digital image with one or more other digital images to produce the final digital image with the determined style.

21. The method of claim 17, wherein determining the one or more visual properties includes determining a used/worn appearance for the final digital image based on usage metadata pertaining to the digital item; and wherein generating the final digital image includes layering the initial digital image with one or more other digital images to produce the final digital image with the used/worn appearance.

22. The method of claim 21, wherein the extent of the used/worn appearance is based on the amount of usage of the digital item according to the usage metadata.

23. A non-transitory computer-readable medium storing instructions which, when executed by one or more computing devices, cause the one or more computing devices to perform the method of claim 1.

24. A non-transitory computer-readable medium storing instructions which, when executed by one or more computing devices, cause the one or more computing devices to perform the method of claim 17.

25. A computing device comprising:
one or more processors;
a memory operatively coupled to the one or more processors;
logic encoded in one or more computer-readable media wherein execution by the one or more processors causes:
obtaining one or more values from attribute metadata pertaining to a digital item;
generating a base-depiction-selector-value based on at least a portion of the one or more values;
accessing a mapping table to select a base visual depiction item using the base-depiction-selector-value;
generating a visual depiction to visually represent the digital item based, at least in part, on the selected base visual depiction item; and
causing display of the visual depiction on a display device.

26. A computing device comprising:
one or more processors;
a memory operatively coupled to the one or more processors;
logic encoded in one or more computer-readable media wherein execution by the one or more processors causes:
obtaining one or more values from attribute metadata pertaining to a digital item;
obtaining an initial digital image representing an initial visual depiction for the digital item;
determining one or more visual properties for a final digital image representing a final visual depiction for the digital item based on at least the one or more values;
generating the final digital image based at least on the initial digital image and the one or more determined visual properties; and
causing display of final digital image on the display device as a visual depiction for the digital item.
